(19) United States
(12) Patent Application Publication
(10) Pub. No.: US 2003/0067657 A1
(43) Pub. Date: Apr. 10, 2003

(54) Method and apparatus to compensate for atmospheric effects and target motion in laser communication system

(76) Inventors: Wolfgang M. Dimmler, Albuquerque, NM (US); Bernard M. Gudaitis, Palos Verdes Estates, CA (US); Juan M. Ceniceros, Placitas, NM (US); Ralph R. Galetti, Albuquerque, NM (US); Matthew Flint Kepler, Albuquerque, NM (US); Mark Laine, Albuquerque, NM (US); Ralph Pringle, Albuquerque, NM (US); Tracy Shurtleff, Albuquerque, NM (US); Frank Zoltowski, Edgewood, NM (US); Joseph N. Paranto, Albuquerque, NM (US); Jeff Connors, Albuquerque, NM (US)

Correspondence Address: HARNESS, DICKEY & PIERCE, P.L.C., P.O. BOX 828, BLOOMFIELD HILLS, MI, 48303, US

(21) Appl. No.: 09/948,727

(22) Filed: Sep. 7, 2001

(51) Int. Cl. H04B 10/00

(52) U.S. Cl. 359/159; 359/172

(57) ABSTRACT

A free-space laser communication system and method for compensating for the atmospheric effects and target motion of a target that may occur during free-space laser communication between of a pair of the systems. Each system makes use of a plurality of narrow infrared (IR) laser beams, a means for pointing and tracking the laser, an adaptive optics system and a communications transceiver. Optionally turbo coding techniques may be used to encode data transmitted by each of the systems. The laser communication system is less susceptible to adverse weather effects that could otherwise negatively influence the operation of an optical communication system.

### FIELD OF THE INVENTION

The present invention relates in general to a free-space laser communication system and, more particularly, to a free-space laser communication method and apparatus designed to compensate for the atmospheric effects and target motion that may occur during free-space laser communication between a pair of such communication systems.

### BACKGROUND OF THE INVENTION

Laser communication systems have shown great promise to replace currently used radio-frequency (RF) communication systems in many applications. Laser communication systems offer more than an order of magnitude improvement in data bandwidth over conventional RF systems. Separate from the growth of fiber optic communication, free-space laser communication requires transmission of directed laser signals through either the atmosphere (terrestrial) or space (extraterrestrial).

Free-space laser communication presents numerous challenges that have limited the growth of such systems in commercial markets. Two of the most significant challenges include compensating for atmospheric affects and maximizing line-of-sight pointing accuracy. The result has been the limited development of large commercial systems that are typically mounted on fixed structures and transmit broad laser beams.

It would therefore be desirable to provide a free-space laser communication system that is smaller than previously designed systems and that is capable of propagating narrow laser beams to and from both fixed and moving platforms. More specifically, it would be desirable to provide a laser communication system that propagates narrow infrared laser beams; compensates for atmospheric effects; and provides for accurate pointing and tracking of the system links in spite of adverse weather conditions that would otherwise negatively impact the performance of the system.

### SUMMARY OF THE INVENTION

In accordance with the present invention, a preferred embodiment of a laser communication system is disclosed which comprises a laser source for producing a plurality of narrow infrared wavelength laser beams, a means for pointing and tracking the laser beams, an adaptive optics subsystem, and a communication transceiver. Preferably, two such laser communication systems are provided to form a two-way free-space laser communication link.

The pointing and tracking subsystem is capable of performing micro-radian class pointing and tracking that is required to take advantage of the benefits that narrow infrared wavelength laser beams provide. The pointing and tracking capability is also an important element in enabling the communication links to be deployed on moving platforms.

The adaptive optics subsystem performs adaptive correction of phase (i.e., path length) variations in the path of an optical communication system. Unlike conventional systems, the present invention does not utilize a separate beacon to measure the phase variations in the beam path, but instead uses the communication channel as the beacon. The adaptive optics subsystem senses aberrations in the beam's path using wavefront sensors located at the receiving end of the communications link. The wavefront information is placed on the communications channel for transfer back to the transmitting system, which uses the information to adjust the properties of the transmitted laser beams to compensate for the beam path phase variations. The adaptive optics subsystem employs a closed loop system that continuously corrects for atmospheric aberrations in the path of the transmitted laser beams.

The communication transceiver preferably utilizes Turbo Code algorithms for data encoding and decoding to partially compensate for signal fades caused by atmospheric variations. Turbo Codes enable the laser communication system to achieve lower bit error rates in the presence of signal fades than is achievable using conventional data encoding/decoding techniques.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified diagram showing a plurality of applications for the laser communication system of the present invention;

FIG. 2 is a functional block diagram of a preferred embodiment of the laser communication system of the present invention;

FIG. 3 is a schematic of the transmitter subsystem of the present invention, including the optics and electronics that produce a modulated, multi-beam link between two transceiver systems;

FIG. 4 is a functional block diagram of the beam pointing and tracking system of the present invention;

FIG. 5 is a diagram of the scanning process performed by each pair of transceivers of the present invention as a means for acquiring a transmitted laser beam;

FIG. 6 shows the re-alignment and re-calibration process each transceiver of the present invention goes through periodically during operation;

FIG. 7 is a simplified block diagram of a prior art laser communication system that uses a beacon separate from the communication laser to detect atmospheric aberrations in the transmitted beam's path;

FIG. 8 is a simplified block diagram of a preferred embodiment of the present invention, wherein the communication laser is also used as a beacon; and

FIG. 9 is a simplified block diagram of another preferred embodiment of the present invention, wherein the wavefront sensor at one end of the communication link is eliminated.

### DETAILED DESCRIPTION OF THE PREFERRED EMBODIMENTS

The following description of the preferred embodiment(s) is merely exemplary in nature and is in no way intended to limit the invention, its application, or uses.

The present invention relates to various aspects of an improved laser communication system. As will become apparent from the remainder of this detailed description, the present invention more particularly relates to the features of a laser communication system that preferably includes a laser source for producing a plurality of narrow beam infrared lasers, an autonomous pointing and tracking subsystem, adaptive optics, and Turbo Coding for data processing. However, while a preferred embodiment of a laser communication system is shown and described herein as a single cooperative apparatus, it will be understood that the various features may be utilized independent from one another.

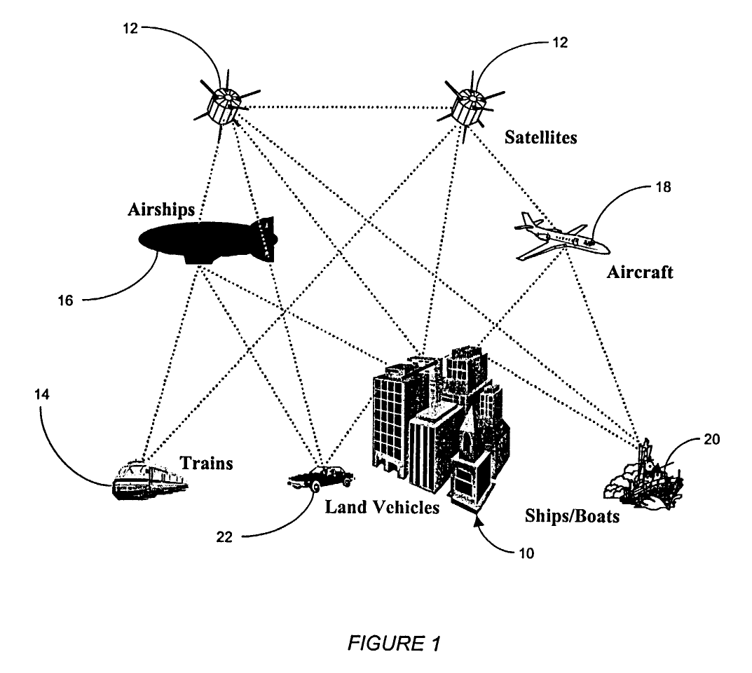

Referring to FIG. 1, there is shown a simplified diagram of the various high data rate communication links that can be established with the apparatus and method of the present invention. For example, communication can be supported for fixed line-of-sight (LOS) points between two or more fixed structures, such as buildings 10, without the need to run fiber optic cables between the buildings. Building-to-building non-LOS communications can be accommodated via one or more airborne or space based relays (i.e., transponders) 12. These relays 12 can also be used to effect non-LOS communication links between mobile platforms such as trains 14, airships 16, aircraft 18, ships 20, and land-based vehicles 22. The present invention can further be used to effect LOS communication links between the mobile platforms 14-22.

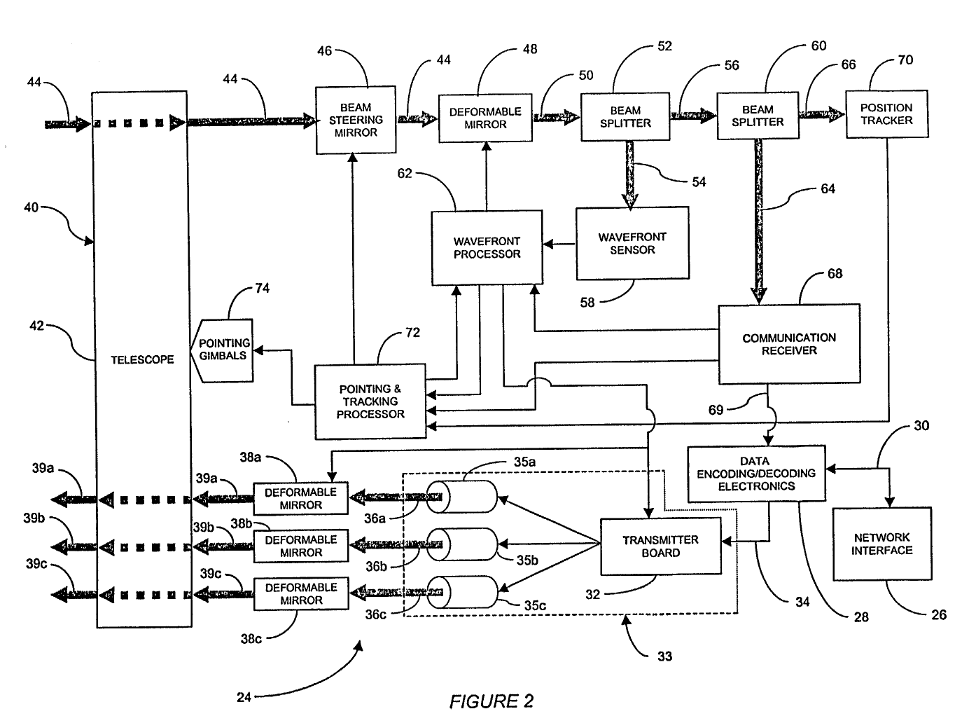

Referring now to FIG. 2, a free-space laser communication system 24 (hereinafter referred to as a transceiver) in accordance with a preferred embodiment of the present invention is illustrated. It will be appreciated that a transceiver 24 will be employed at each end of a communication link (hereinafter, each end shall be referred to separately as 24a and 24b), such as, for example, on aircraft 18 and one of buildings 10, to effect a free-space laser communication system.

Transceiver 24 generally includes a conventional network interface 26 that connects transceiver 24 to various data sources that are well known to those skilled in the art. Network interface 26 produces an output that is communicated to data encoding/decoding electronics 28 via a conventional fiber optic cable 30 or other suitable connecting device. The encoded data is transferred from encoding/decoding electronics 28 to transmitter board 32 through a suitable conductor, for example, a conventional 50-ohm coaxial cable 34. Transmitter board 32 superimposes the data upon a plurality of laser beams 36a-36c for transmission to the other end of the communication link. The laser beams 36a-36c are generated by a laser beam generating subsystem 33, which is comprised of the transmitter board 32 and laser beam generating sources 35a-35c. Before exiting transceiver 24, the optical characteristics of the laser beams are modified by means of deformable mirrors 38a-38c. These adjustments are necessary to correct for fluctuations in beam intensity due to scintillation caused by atmospheric variations in the path of the laser beams, thereby producing optically corrected laser beams 39a-39c. Finally, laser beams 39a-39c pass through an aperture 42 formed by the body of telescope 40, whereupon the laser beams travel along substantially parallel paths through the atmosphere to the other end of the communication link.

In addition to providing a means for aiming laser beams 39a-39c, telescope 40 also provides a means for receiving laser beams transmitted from the other end of the communication link. Received laser beams 44 pass through aperture 42 of telescope 40 and are directed onto beam steering mirror 46 by means of a series of mirrors not shown, but which are well known to the skilled artisan. Beam steering mirror 46 focuses the received laser beams 44 onto a deformable mirror 48. Deformable mirror 48 performs a similar function as deformable mirrors 38a-38c, in that deformable mirror 48 adjusts the optical characteristics of received laser beams 44 to correct for fluctuations in beam intensity due to scintillation caused by atmospheric variations in the path of the laser beams. Deformable mirror 48 generates an optically corrected laser beam 50.

Laser beam 50, the properties of which have been previously adjusted using deformable mirror 48, is split into two separate beams 56 and 54 by means of a conventional beam splitter 52. Beam splitter 52 does not alter the optical characteristics of beams 54 and 56. Laser beam 54 is directed towards a wavefront sensor 58 which is used to analyze the optical characteristics of the received laser beam. Wavefront sensor 58 produces an output that is sent to a wavefront processor 62. Wavefront processor 62 compares the optical characteristics of the received beam to those of a reference laser beam that has no atmospherically induced aberrations (i.e., a theoretically perfect laser beam). If wavefront processor 62 determines that the optical characteristics of the received laser beams 44 differ from those of the reference laser beam, wavefront processor 62 sends a signal to deformable mirror 48 instructing the mirror to adjust the optical properties of the received laser beams 44 in order to produce laser beam 50, which is free of atmospherically induced aberrations. Essentially, components 48, 52, 58, and 62 form a closed loop system that continuously corrects, in real time, for atmospheric effects that could optically distort laser beams 44. Deformable mirrors 38a-38c and 48, wavefront sensor 58, and wavefront processor 62 comprise the adaptive optics subsystem, the features of which are discussed in greater detail below.

With further reference to FIG. 2, beam 56 passes through a second conventional beam splitter 60. Beam splitter 60 divides beam 56 into two optically equivalent beams 64 and 66, which are utilized by a communication receiver 68 and a position tracker 70, respectively. Communication receiver 68 extracts the embedded data from laser beam 64 using a known method and transfers the information to the appropriate communication system components. In a preferred embodiment of the present invention, beam 64 will not only carry communication data, but will also carry wavefront and pointing and tracking information. Communication receiver 68, utilizing a suitable known extraction method, extracts the wavefront information from the received laser beam 64 and sends the information electronically to wavefront processor 62 for processing. Wavefront processor 62 uses the information to determine the proper setting for deformable mirrors 38a-38c. Communication receiver 68 also extracts the pointing and tracking data from received laser beam 64 and communicates the information to a pointing and tracking processor 72. Finally, communication receiver 68 extracts the communication data, which is sent to data encoding/decoding electronics 28 for decoding. The decoded data is sent to network interface 26, which is preferably coupled to one or more known processors that have been adapted to handle the data and place the same in a usable form or format.

Continuing to refer to FIG. 2, after leaving beam splitter 60, beam 66 impinges upon position tracker 70, which produces a calibrated signal that is communicated to pointing and tracking processor 72. Based on the calibrated signal, the pointing and tracking processor 72 determines the amount of correction, if any, that needs to be made to the pointing angle of telescope 40 and beam steering mirror 46. The pointing position of telescope 40 is adjusted by means of pointing gimbals 74, which are controlled by the pointing and tracking processor 72. Position tracker 70, pointing and tracking processor 72, beam steering mirror 46, pointing gimbals 74, and telescope 40 comprise the pointing and tracking subsystem, the features of which are discussed in greater detail below.

With the foregoing description of a preferred embodiment of transceiver 24 as background, the various specific features of the present invention will now be described in greater detail.

I. Narrow Beam Infrared Laser Source

Preferably, as indicated in FIG. 2, a minimum of three laser sources 35a-35c will be utilized to generate the transmitted laser beams 36a-36c. Each laser source 35a-35c generates a single infrared laser beam with a wavelength of preferably about 1.55 micrometers. Laser sources 35a-35c are preferably spaced apart by some predetermined distance that will allow the emitted laser beams 36a-36c to be separated upon leaving their respective source. Although each laser beam 36a-36c will initially be separated, all of the beams will preferably overlap to some extent upon reaching the receiver at the other end of the communication link. Using multiple transmitters operating at a wavelength of about 1.55 micrometers wavelength allows for averaging of the signal power at the receiving end of the communication link, thereby increasing the overall signal strength. Moreover, using multiple transmitters versus a single transmitter increases the probability that the receiver will have enough signal power to decode the transmitted data.

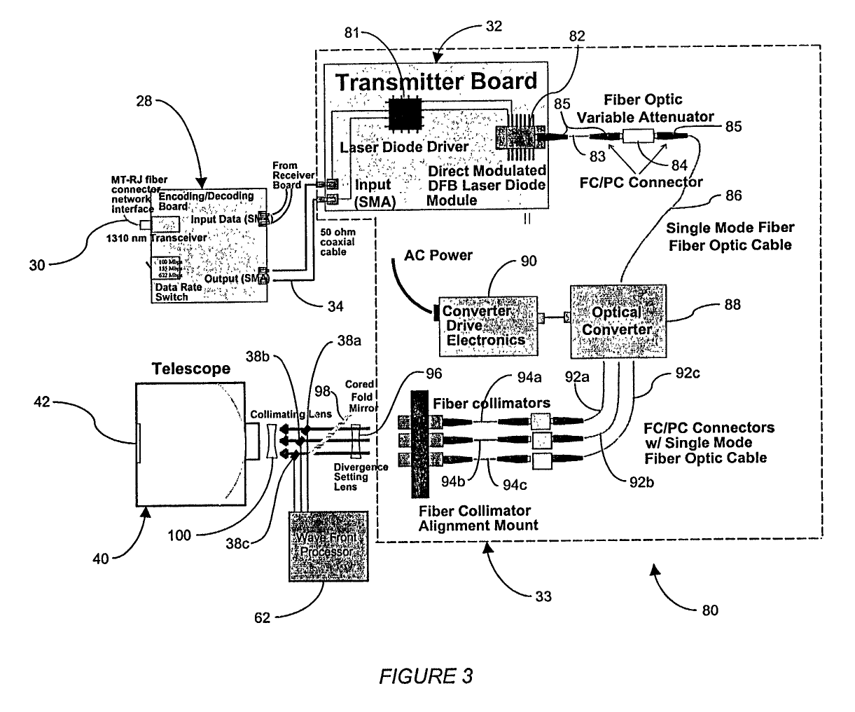

Referring now to FIG. 3, there is shown a preferred embodiment of a communication transmitter 80 for generating multiple infrared laser beams used to transmit data between the ends of a communication link. As described herein, encoding/decoding electronics 28 receives data from network interface 26 (shown in FIG. 2) by means of the conventional fiber optic cable 30. The data is encoded by means of Turbo Coding algorithms that are stored in a memory of the encoding/decoding electronics 28. Although Turbo Codes are well known and commonly used within the communication industry, adapting turbo codes for use in connection with a free-space laser communication system is believed to be a novel application of this technology. Turbo Coding is discussed in greater detail below.

Encoding/decoding electronics 28 produces an output signal that is communicated to the transmitter board 32, preferably by means of the 50-ohm coaxial cable 34. The encoded data acts as an input signal for a laser diode driver 81, which produces a control signal that directly modulates a laser diode 82. Although the light beam is preferably generated using a compact semi-conductor diode, it shall be appreciated that there are other equally acceptable methods for generating a beam of light in accordance with the present invention. Laser diode 82 produces an infrared light beam that passes through a conventional single mode fiber optic cable 83 to a known fiber optic variable attenuator 84. Variable attenuator 84 provides a means for adjusting the intensity of the light beam produced by laser diode 82. Conventional FC/PC connectors 85 are used to connect cable 83 to components 82 and 84.

The infrared beam travels from variable attenuator 84 through a conventional single mode fiber optic cable 86 to optical converter 88. Fiber optic cable 86 is connected to variable attenuator 84 using conventional FC/PC connector 85. Optical converter 88 splits the single infrared beam into multiple beams, each of which has a different wavelength. Lastly, optical converter 88 amplifies all of the infrared beams to the same power level.

The infrared beams travel from optical converter 88 through conventional single mode fiber optic cables 92a-92c to fiber collimators 94a-94c. Fiber collimators 94a-94c are of a conventional design and function by expanding and collimating the infrared beams. Upon exiting fiber collimators 94a-94c, the infrared beams pass through a divergence setting lens 96 that is used to set the beam divergence to some predetermined level, which is preferably in the range of 100 TO 500 microradians. The infrared beams then pass through a conventional cored fold mirror 98. Upon exiting core fold mirror 98, the beams are directed upon a set of deformable mirrors 38a-38c, which adjust the optical properties of the beams based upon inputs received from wavefront processor 62. Deformable mirrors 38a-38c and wavefront processor 62 are discussed in greater detail in the Adaptive Optics section found below. The infrared beams then pass through a conventional collimating lens 100, which produces very narrow laser beams with diameters preferably in the range of 1 to 3 cm. The laser beams exit the system by passing through aperture 42 of telescope 40.

II. Autonomous Pointing and Tracking

To benefit from the link margin advantages of a narrow beam laser communication system, it is strongly preferable that the system be able to achieve micro-radian class pointing accuracy. Referring again to FIG. 2, pointing and tracking is preferably performed by means of the conventional gimbals 74 and the telescope 40, which provides coarse, large-angle pointing capabilities, and beam steering mirror 46, which provides high-bandwidth control of small angular motions and tilt correction. Pointing and tracking processor 72 controls the movement of telescope 40 and beam steering mirror 46 based on information received from position tracker 70 and communication receiver 68.

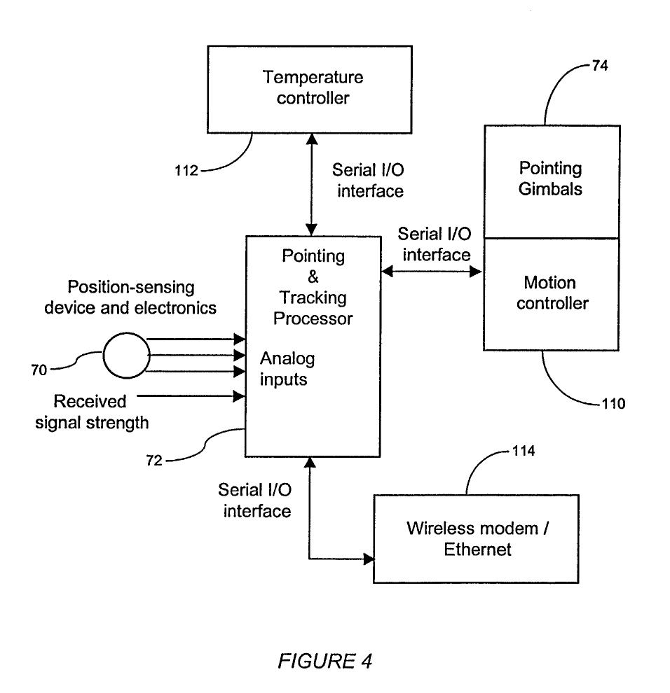

Referring to FIG. 4, the pointing and tracking subsystem is implemented via pointing and tracking processor 72. Pointing and tracking processor 72 determines the received signal strength, the position of the received laser beam on the detector, and the communication signal transforms. Pointing and tracking processor 72 utilizes conventional serial interfaces to connect the processor to the various communication system components, including position sensing device 70, a temperature controller 112, a motion controller 110, and a wireless communication apparatus 114. Motion controller 110 controls the position of telescope 40 and beam steering mirror 46, both of which are shown in FIG. 2.

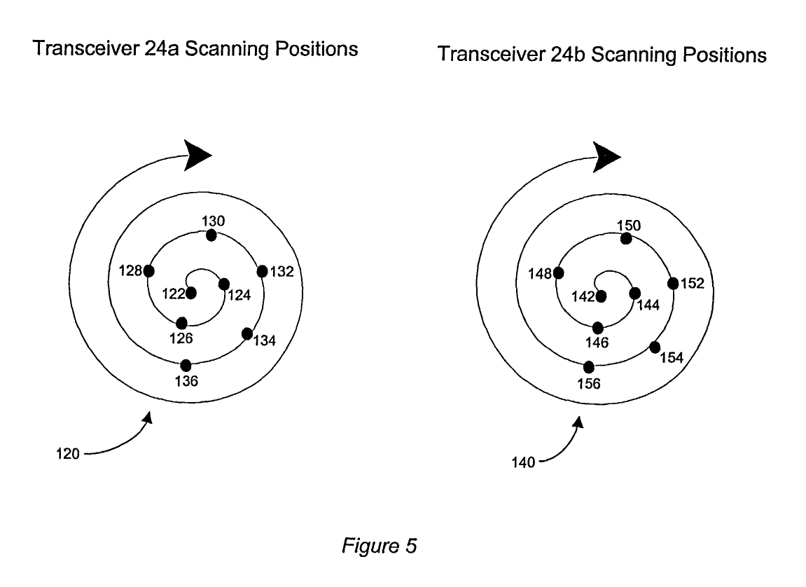

The pointing and tracking subsystem's functions include initially aligning transceivers 24a and 24b, maintaining the maximum laser beam energy on the detector (not shown) of communication receiver 68 (see FIG. 2) during system operation, and performing periodic realignment and recalibration of the pointing and tracking subsystem (i.e., components 40, 46, 70, 72, and 74). Initial alignment is performed during installation as part of the set-up process and includes manually pointing transceivers 24a and 24b at each other. When transceivers 24a and 24b are pointing towards one another the automated acquisition process can begin. The process commences with the pointing and tracking subsystem of transceivers 24a and 24b each performing a nested pair of conical scans 120 and 140 as shown in FIG. 5. The scans are performed using the transmitted laser beams from transceivers 24a and 24b. The pointing and tracking processors 72 (see FIGS. 2 and 4), one of which is included as part of each transceiver 24a and 24b, are time-synchronized so that the nested pair of conical scans are performed at the appropriate time.

Still referring to FIG. 5, transceivers 24a and 24b begin their respective scans at some pre-synchronized time. Transceiver 24a holds its pointing gimbals 74 (see FIG. 2) at position 122 of conical scan pattern 120, while transceiver 24b uses its pointing gimbals to scan through positions 142, 144, 146, . . . , n, of conical scan pattern 140, where n is some pre-determined number of steps. After transceiver 24b completes conical scan 140, transceiver 24a then moves to position 124 of conical scan pattern 120, and transceiver 24b repeats conical scan pattern 140. When transceiver 24a detects a laser beam from transceiver 24b on its receiver, transceiver 24a stops and holds its position. Since the transmitter and receiver subsystems of transceiver 24 share the same optical telescope 40, and the laser beams produced by transceivers 24a and 24b are the same diameter, when transceiver 24a detects a beam from transceiver 24b on its communication receiver (element 68 of FIG. 2), transceiver 24b will also detect a beam from transceiver 24a on its communication receiver (element 68 of FIG. 2). Accordingly, transceiver 24b will also hold at the detected beam position. Initial acquisition for transceivers 24a and 24b will then be established.

Once initial acquisition is established, transceivers 24a and 24b automatically transition to a closed loop tracking mode as a means for maintaining the beam from each transceiver on the detector of communication receivers 68 of its system 24 (see FIG. 2). Transceivers 24a and 24b store in memory their respective position pointing angles as established during the initial acquisition procedure. While operating in the closed loop tracking mode, each transceiver maintains its respective position pointing angle despite motion caused by building sway, wind, vibration, or atmospheric effects.

Each transceiver 24a and 24b also maintains in memory a pointing angle time history. If acquisition is lost, automatic re-acquisition can begin at the last known valid pointing angle. The time history provides an improved re-initialization pointing angle that will enable the system to reestablish a communication link after long periods of signal loss (which may be caused, for example, by very dense fog). Typically, the optimum pointing angle is a historical function of temperature and/or time of day. Finally, while operating in the closed loop tracking mode, each transceiver will periodically re-synchronize in time so if alignment and tracking are lost, the time synchronization protocol will dictate when reacquisition starts.

During operation, each transceiver may require periodic in-system realignment and recalibration. Realignment and recalibration equates to making the outgoing beam path the same as the incoming line-of-sight zero-error track reference. The new offset track reference maximizes the output energy to the other transceiver's receiver.

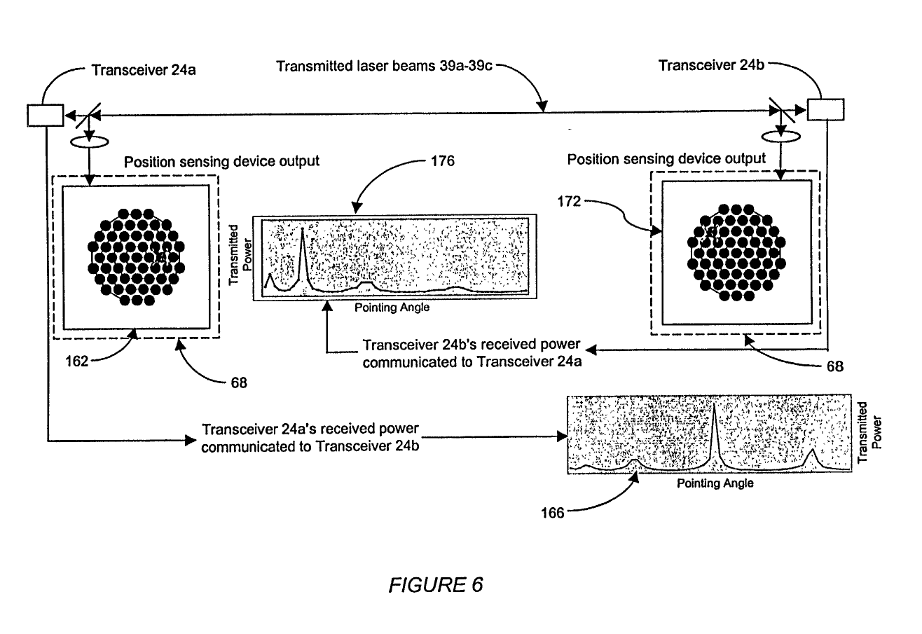

Referring to FIG. 6, realignment and recalibration consists of transceiver 24a performing a peak power scan with its laser 39a-39c while transceiver 24b's position sensing device 172 (part of communication receiver 68) measures received power for each pointing angle of transceiver 24a's scan. Transceiver 24b transmits its received power back to transceiver 24a, where the information is used to determine transceiver 24a's peak transmitting power as a function of pointing angle, a sample of which is shown graphically at 176. After transceiver 24a completes its peak power scan, transceiver 24b then commences the same peak power scan while transceiver 24a's position sensing device 162 (part of communication receiver 68) measures received power for each pointing angle of transceiver 24b's scan. Transceiver 24a transmits it received power back to transceiver 24b where the information is used to determine transceiver 24b's peak transmitting power as a function of pointing angle, a sample of which is shown graphically at 166. The updated offsets are saved in memory as new zero-error track references on transceiver 24a and 24b's position sensing devices 162 and 172 respectively. The received power measurement taken at each step of a peak power scan is time averaged long enough to provide an overall power measurement that is independent of short-term atmospheric effects.

III. Adaptive Optics

The adaptive optics subsystem of the laser communication system of the present invention provides adaptive correction of phase (path length) variations in the path of the laser beam. Referring back to FIG. 2, the adaptive optics subsystem is comprised of the wavefront sensor 58, which is used to sense the aberrations in the transmitted beam's path, the wavefront processor 62, which is used to process the data produced by wavefront sensor 58, and the deformable mirrors 48 and 38a-38c, which are used to correct for the aberrations in the beam's path. The conventional beam splitter 52 provides a reference beam for wavefront sensor 58. The adaptive optics subsystem and the known reconstruction algorithms used to control deformable mirrors 38a-38c and 48 are used to correct for the aberrations in the beam path between the two ends of the communication link.

Wavefront sensor 58 is used to sense the perturbations in the beam path between the ends of the communication link. The skilled artisan will appreciate that there are many types of known wavefront sensors that can be used to perform this function, including interferometric and Hartmann approaches. Furthermore, those skilled in the art will appreciate that wavefront sensor 58 can be used to either directly observe the phase tilt of the beam path or indirectly observe an affect caused by the aberrations, such as a change in the transmitted beam's intensity or image sharpness.

Although conventional adaptive optic systems have the capability to correct for significant atmospheric aberrations, it will also be understood by persons skilled in the art that the signal-to-noise ratio of conventional wavefront sensors, as well as the speed of the camera and processors used in connection with the wavefront sensors, effectively limit the amount of correction that can be performed by an adaptive optics system. However, by using one of the techniques shown in FIGS. 8 and 9, it is possible to alleviate the signal-to-noise limitation.

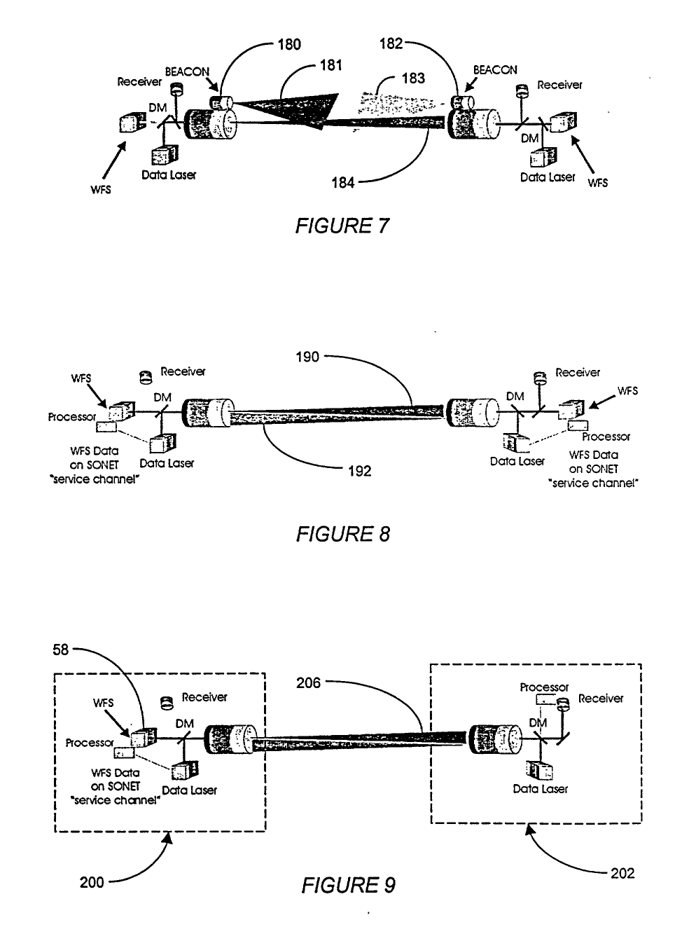

Referring to FIG. 7, a simplified diagram of a laser communication system is shown that uses a conventional method of wavefront correction. In this method, beacons 180 and 182 produce reference laser beams 181 and 183, respectively, used to sense the atmospheric aberrations in the paths of the beams. Beams 181 and 183 are never corrected before being transmitted and are therefore susceptible to the full depth of fading (aberrations) caused by the atmosphere. On the other hand, if the beams 181 and 183 were corrected prior to being transmitted, or, more economically, a transmit laser beam 184 is used as a beacon, the fading effects of the atmosphere can be progressively corrected and the signal-to-noise ratio requirement placed on the wavefront sensor can be reduced.

Now referring to FIG. 8, there is shown a simplified diagram of a laser communication system in which transmit laser beams 190 and 192 are used as beacons, in accordance with a preferred embodiment of the present invention. This scheme, however, requires that wavefront information from one end of the communication link be transmitted at a high data rate to the other end of the link. Since this is a high-speed communications system, the wavefront information will preferably be placed on a SONET service channel or pilot tone.

Continuing to refer to FIG. 8, although the beacon used in a conventional adaptive optics system (see FIG. 7) is typically separate from the communication beam that is being corrected, it is nevertheless assumed that most atmospheric effects are “seen” by the beacon. However, because the beacon is not corrected prior to being transmitted, the amount of correction that the adaptive optics subsystem can achieve is limited by its own signal-to-noise ratio. To overcome this limitation, transmit lasers 190 and 192, which are used as beacons in a preferred embodiment of the present invention, are pre-corrected by the transmitter's adaptive optics subsystem using deformable mirrors 38a-38c, which are shown in FIG. 2. Since the transmit beams 190 and 192 have been pre-corrected before reaching the wavefront sensor 58 of the receiving transceiver 24, the fading effects that limit the use of a conventional wavefront sensors are minimized. To ensure that the entire atmosphere is sampled though, the wavefront information must be made available to the transceiver 24 at the other end of the communication link to allow it to fully correct its beam. Allowing the wavefront information to be placed on the communications channel (i.e., beams 190 and 192) for use by the communication receiver 68 (see FIG. 2) reduces the effects of wavefront sensor sensitivity and dynamic range and allows transmitted lasers 190 and 192 to be used as beacons for the adaptive optics subsystem.

Referring again to FIG. 2, deformable mirrors 48 and 38a-38c cooperate with one another to correct for atmospheric aberrations in the transmitted beam's path. Deformable mirror 48 provides phase delays in the optical path to compensate for the aberrations sensed by wavefront sensor 58. If the aberrations become too large for deformable mirror 48 to completely correct, wavefront processor 62 instructs deformable mirrors 38a-38c to precondition transmit lasers 36a-36c with a phase profile. This results in the corrected laser beams 39a-39c, which possess near-diffraction limited beam divergence upon arriving at the transceiver 24 at the other end of the communication link.

Although the adaptive optics subsystem preferably employs miniature electro-mechanical systems (MEMS) deformable mirrors due to their performance capability and potential for low cost, it will be appreciated that there are other alternative apparatuses that may be used to achieve the same result. However, by using deformable mirrors in a free-space laser communication architecture, a cost-effective solution can be achieved to adaptive-optics correction of the communication path.

For those applications where one end of the communication link is located on a moving platform, for example where the communication link is established between an aircraft 18 and a building 10 (see FIG. 1), the wavefront sensor on the stationary end of the communication link (i.e., building 10 of FIG. 1) is preferably eliminated. Referring to FIG. 9, there is shown, in accordance with another preferred embodiment of the present invention, a simplified diagram of a laser communication system in which only the transceiver employed on the mobile end of the communication link 200 (i.e., on aircraft 18 of FIG. 1) utilizes a wavefront sensor 58. System 202 is identical to transceiver 24, except that it does not include a wavefront sensor 58. System 202 is disposed at the stationary end of the communication link (i.e., on building 10 of FIG. 1). All wavefront information is transmitted from the mobile transceiver 200 to the stationary transceiver 202 via transmit laser 206.

IV. Data Encoding and Decoding

A preferred embodiment of the present invention incorporates Turbo Code type algorithms for encoding and decoding the transmitted data as a means to partially compensate for the signal fades caused by atmospheric scintillation. Although adapting Turbo Codes for use in telecommunication devices is not new per se, these codes are not believed to have been adapted for use with a laser communication system. The Turbo Codes are preferably incorporated as part of the data encoding/decoding electronics 28 (see FIGS. 2 and 3).

A Turbo Code is a parallel concatenation of two or more systematic codes that can reduce bit error rates (BERs) in the presence of signal fades. Turbo Codes allow a communications system to achieve lower BERs in the presence of fading. Turbo Codes, which were introduced by Berrou, Glavieux and Thitimasjshima in 1993, offer large block code lengths, while keeping complexity of the decoder to a minimum. The key to the encoder is a pseudo-random interleaver followed by recursive encoders. The parallel output from each is concatenated to form a Turbo Code.

Many kinds of fading are assumed in the literature for radio transmission such as Rayleigh, Nakagami, and Rician. The simplest model, Rayleigh, assumes that the channel has multiple paths whose magnitude is Gaussian distributed and phase is uniformly distributed. None of these models, however, are accurate for a laser transmitted through the atmosphere. Since the index of refraction structure function has Kolmogorov statistics, the power received is usually assumed to have a lognormal distribution. It should be noted that the lognormal distribution degrades the signal in a channel by increasing the standard deviation as the signal mean decreases. Application of the Turbo Coder to propagation through the atmosphere will improve the BER of the communication link, which will thereby improve the overall communication link efficiency.

The detailed description of the invention is merely exemplary in nature and, thus, variations that do not depart from the gist of the invention are intended to be within the scope of the invention. Such variations are not to be regarded as a departure from the spirit and scope of the invention.

What is claimed is:

1. A free space two-way laser communication system for establishing a two-way, free-space communication link, comprising:
a laser transmitter for generating a narrow beam infrared signal for carrying communication data adapted to be received by an independent laser communication device at a location remote from said communication system; and
a pointing and tracking system for aiming said infrared signal at said independent laser communication device and for tracking said independent laser communication device.

2. The system of claim 1, wherein said laser transmitter generates a narrow beam infrared signal having a wavelength of about 1.55 micrometers.

3. The system of claim 1, further comprising a position sensing device for detecting a position of said independent laser communication device.

4. The system of claim 1, further comprising a telescope for receiving an infrared signal from said independent laser communication device.

5. The system of claim 4, further comprising a beam steering mirror for receiving said infrared signal from said telescope.

6. The system of claim 1 further comprising a communication receiver for receiving an infrared signal from said independent laser communication device.

7. The system of claim 1 further comprising an adaptive optics subsystem for correcting for phase variations in the path of said infrared signal.

8. The system of claim 1, further comprising a data encoding/decoding electronics subsystem responsive to said communication receiver for encoding and decoding said communication data.

9. A free-space communication system consisting of at least two ends, with each end having substantially identical two-way laser communication systems that are in communication with each other to form a two-way free-space laser communication link, wherein each end of said laser communication link is comprised of:
a laser transmitter for generating a narrow beam infrared signal for carrying communication data adapted to be received by the communication system at an opposite end of said communication link;
a pointing and tracking system for aiming said narrow beam infrared signal at said opposite end of said communication link and for tracking said system at said opposite end of said communication link;
a communication receiver for receiving said infrared signal; and
a data encoding/decoding electronics subsystem responsive to said communication receiver for decoding said communication data.

10. The system of claim 9, wherein said pointing and tracking subsystem comprises:
a telescope for receiving said infrared signal generated by said laser transmitter;
a beam steering mirror for receiving said infrared signal from said telescope;
a position sensing device for detecting the position of the communication system at said opposite end of said communication link; and
a digital processor for determining signal strength and processing tracking data received from said position sensing device from which said digital processor produces a signal for controlling an orientation of said telescope and said beam steering mirror.

11. The system of claim 9, further comprising an adaptive optics subsystem for correcting for phase variations in the path of said infrared signal.

12. The system of claim 11, wherein said adaptive optics subsystem comprises:
a wavefront sensor for detecting aberrations in the path of said infrared signal;
a deformable mirror for correcting for phase variations in said infrared signal caused by said aberrations; and
a wavefront processor for processing data received from said wavefront sensor from which said wavefront processor generates a signal for controlling said deformable mirror.

13. The system of claim 9, further comprising a network interface for adapting said laser communication system for use with an external apparatus.

14. The system of claim 9, wherein said data encoding/decoding electronics utilize Turbo Codes to encode and decode said communication data.

15. A method for pointing and tracking the ends of a free-space communication system consisting of at least two ends, with each end having substantially identical two-way laser communication systems that are in communication with each other to form a two-way free-space laser communication link, the method comprising the steps of:
initially aligning the laser communication systems at each end of said communication link prior to commencing transmission of a laser communication signal from at least one of said systems;
maintaining alignment of said laser communication systems during operation of said systems; and
performing periodic realignment and recalibration of the laser communication systems of said communication link at predetermined time intervals.

16. The method of claim 15, wherein the step of initially aligning said laser communication systems comprises the steps of:
manually pointing the laser communication systems of said communication link in the direction of one another;
having the laser communication systems of said communication link perform a nested pair of conical scans at a synchronized predetermined time with each said laser communication system transmitting a laser beam as a means for establishing an initial acquisition of said opposite one of said laser communication systems.

17. The method of claim 15, wherein the step of maintaining the alignment of said laser communication systems during operation of said laser communication link further comprises:
storing a position pointing angle of each laser communication system that was established during said initial alignment of said laser communication systems;
maintaining a position pointing angle time history for said communication systems; and
performing automatic re-acquisition, which commences at a last known position pointing angle as obtained from said position pointing angle time history.

18. The method of claim 15, wherein the step of performing the periodic realignment and recalibration of said laser communication systems at predetermined time intervals further comprises:
having each said laser communication system perform a peak power scan at predetermined time intervals to determine a power off-set for each said laser communication system;
storing said power off-sets as a new zero-error track reference to be used by a position sensing device of said laser communication system.
